(19) United States
(12) Patent Application Publication
(10) Pub. No.: US 2014/0367240 A1
(43) Pub. Date: Dec. 18, 2014

(54) KEYSWITCH AND KEYBOARD THEREWITH

(71) Applicants: DARFON ELECTRONICS (SUZHOU) CO., LTD., Suzhou (CN); DARFON ELECTRONICS CORP., Taoyuan (TW)

(72) Inventors: Chin-Hung Lin, Taoyuan (TW); Liang-Ta Yeh, Taoyuan (TW)

(73) Assignees: DARFON ELECTRONICS (SUZHOU) CO., LTD., Suzhou (CN); DARFON ELECTRONICS CORP., Taoyuan (TW)

(21) Appl. No.: 14/272,506

(22) Filed: May 8, 2014

(30) Foreign Application Priority Data
Jun. 17, 2013 (TW) 102211282

(51) Int. Cl. H01H 13/7065; H01H 13/14; H01H 3/12

(52) U.S. Cl. CPC H01H 13/7065; H01H 3/125; H01H 13/14; H01H 2221/058; H01H 2209/01
USPC 200/5 A; 200/344

(57) ABSTRACT

A key switch disposed on a base of a keyboard is disclosed. The key switch includes a key cap, an edge plate, a linkage bar and a sliding end. The key cap is disposed above the base. The edge plate is connected to the base, and a slot is formed on the edge plate. The linkage bar is for connecting the keycap and the base. The sliding end is connected to an end of the linkage bar, and the sliding end is slidably disposed in the slot and abuts against a top surface of the base, wherein a cross section area of the sliding end is smaller than a cross section area of the end of the linkage bar.

### BACKGROUND OF THE INVENTION

1. Field of the Invention

The present invention relates to a key switch and a keyboard therewith, and more particularly, to a thin key switch and a keyboard therewith.

2. Description of the Prior Art

With development of personal computer industry, a keyboard has been one of the input instruments for inputting words, symbols, numerals and so on. Recently, most electronic devices have light-thin designs, leading the keyboard implemented in the electronic device to be developing toward a trend with thin in size. However, lots of mechanisms, such as plunger, rubber dome, linkage bar and so on, are disposed inside the keyboard, which occupies a specific internal volume of a key switch of the keyboard. Accordingly, it constrains height of the key switch and disadvantages in designs of the key switch and the keyboard toward the trend with thin in size. Thus, design of the key switch and keyboard with thin in size has become an issue in the industry.

### SUMMARY OF THE INVENTION

The present invention provides a thin key switch and a keyboard therewith for solving above drawbacks.

According to an embodiment of the present invention, a key switch disposed on a base of a keyboard includes a key cap, an edge plate, a linkage bar and a sliding end. The key cap is disposed above the base. The edge plate is connected to the base, and a slot is formed on the edge plate. The linkage bar is for connecting the key cap and the base. The sliding end is connected to an end of the linkage bar, and the sliding end is slidably disposed in the slot and abuts against a top surface of the base, wherein a cross section area of the sliding end is smaller than a cross section area of the end of the linkage bar.

According to another embodiment of the present invention, a keyboard includes a base and at least one key switch. The base has a top surface, and the at least one key switch is disposed on the base. The at least one key switch includes a key cap, an edge plate, a linkage bar and a sliding end. The key cap is disposed above the base. The edge plate is connected to the base, and a slot is formed on the edge plate. The linkage bar is for connecting the key cap and the base. The sliding end is connected to an end of the linkage bar, and the sliding end is slidably disposed in the slot and abuts against a top surface of the base, wherein a cross section area of the sliding end is smaller than a cross section area of the end of the linkage bar.

In summary, the cross section area of the sliding end connected to the end of the linkage bar of the present invention is smaller than the cross section area of the end of the linkage bar. When the sliding end abuts against the top surface of the base, the aforesaid structural design of the sliding end allows the sliding end to approach the base, so as to reduce the height of the linkage bar. Furthermore, the linkage bar is connected to the key cap, leading to that the key cap is activated by the linkage bar to move toward the base. In such a manner, the overall height of the key switch decreases, and thus it advantages in designs of the key switch and the keyboard toward the trend with thin in size.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a keyboard according to an embodiment of the present invention.

FIG. 2 is a partly diagram of a key switch according to the embodiment of the present invention.

FIG. 3 is a partly exploded diagram of the key switch according to the embodiment of the present invention.

FIG. 4 is a partly exploded diagram of the key switch in another view according to the embodiment of the present invention.

FIG. 5 is a sectional diagram of the key switch along line X-X in FIG. 2.

FIG. 6 is a diagram of the key switch in another view according to the embodiment of the present invention.

FIG. 7 is a partly diagram of a linkage bar according to the embodiment of the present invention.

FIG. 8 is a partly diagram of a linkage bar according to another embodiment of the present invention.

FIG. 9 is a partly diagram of a linkage bar according to another embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

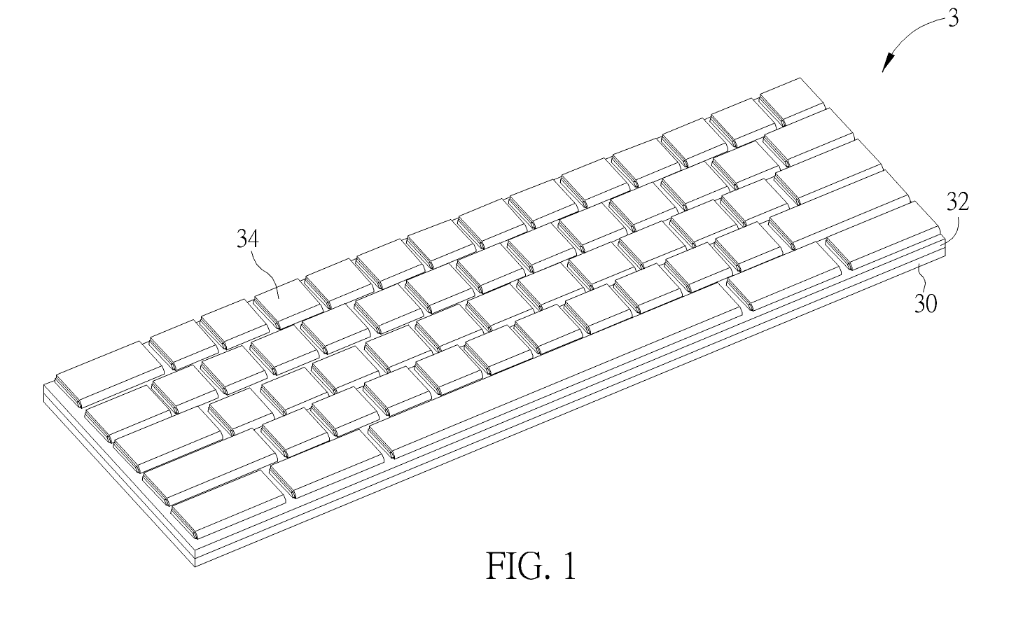

Please refer to FIG. 1. FIG. 1 is a diagram of a keyboard 3 according to an embodiment of the present invention. As shown in FIG. 1, the keyboard 3 includes abase 30, a circuit board 32 and a plurality of key switches 34. The circuit board 32 and the plurality of key switches 34 are disposed on the base 30, and the plurality of key switches 34 are provided for a user to press, so as to activate the circuit board 32 for performing desired operations, such as inputting words, symbols, numerals and so on.

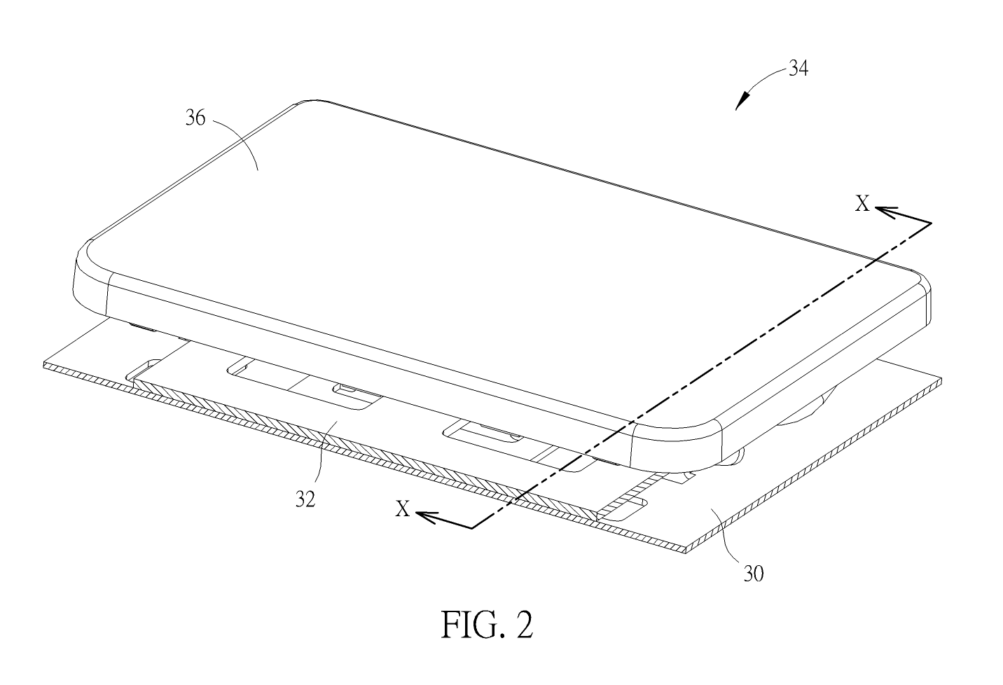

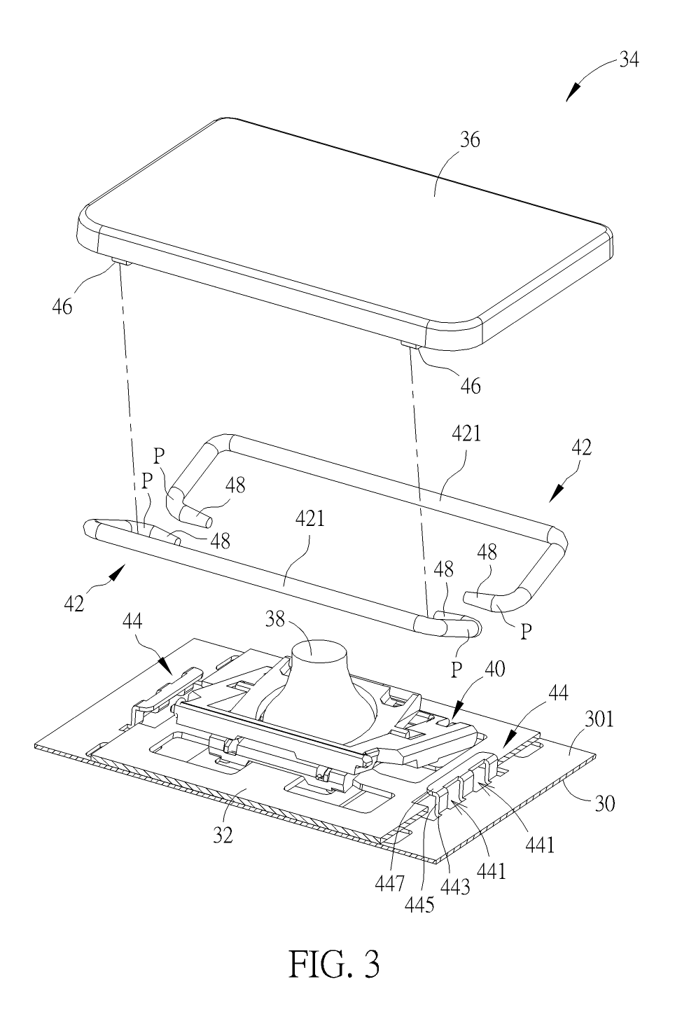

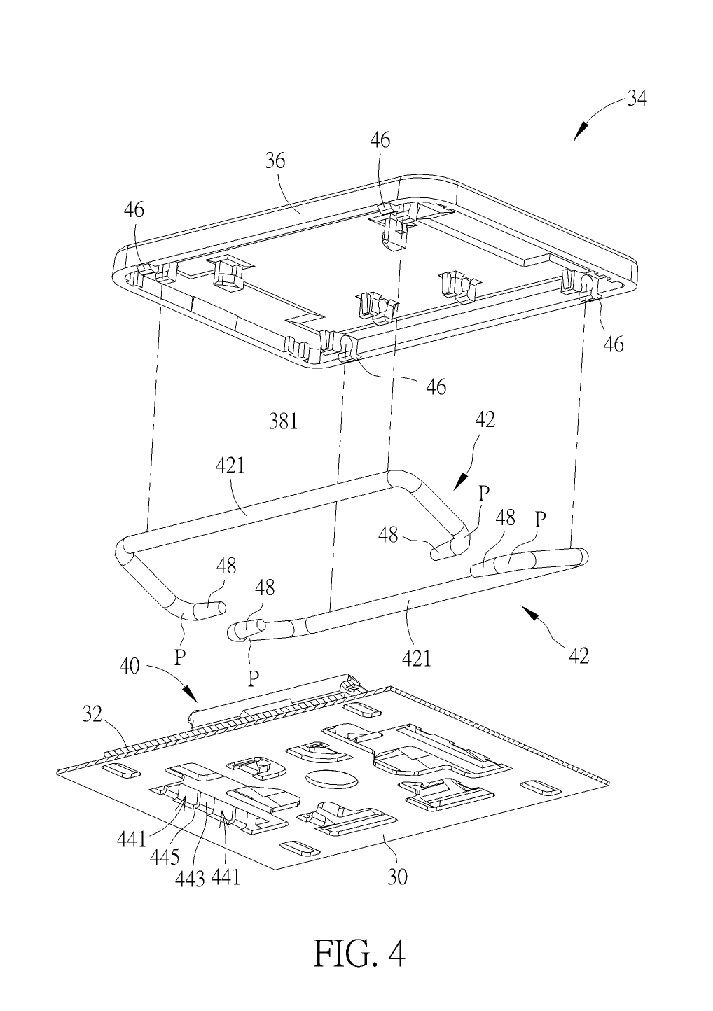

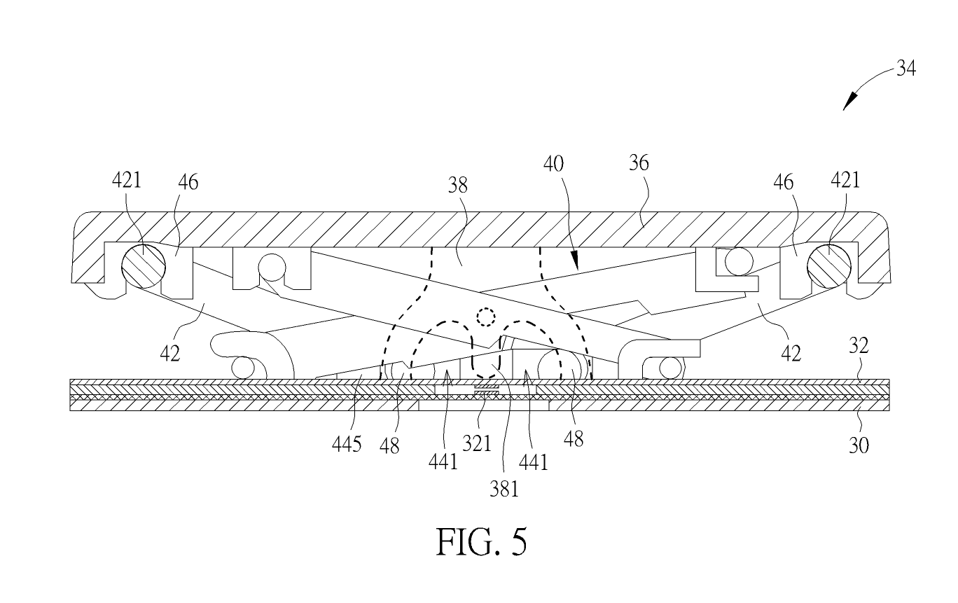

Please refer to FIG. 2 to FIG. 5. FIG. 2 is a partly diagram of the key switch 34 according to the embodiment of the present invention. FIG. 3 is a partly exploded diagram of the key switch 34 according to the embodiment of the present invention. FIG. 4 is a partly exploded diagram of the key switch 34 in another view according to the embodiment of the present invention. FIG. 5 is a sectional diagram of the key switch 34 along line X-X in FIG. 2. As shown in FIG. 2 to FIG. 5, the key switch 34 includes a key cap 36 and a resilient member 38. The key cap 36 is disposed above the base 30, and the resilient member 38 is disposed between the base 30 and the key cap 36. When the key cap 36 is pressed, the key cap 36 moves toward the base 30 and compresses the resilient member 38. Meanwhile, the resilient member 38 deforms elastically and stores a potential energy. When the key cap 36 is released, the resilient member 38 releases the potential energy and applies the key cap 36 with a resilient force, so as to recover the key cap 36.

In this embodiment, the resilient member 38 can be a rubber dome, but the present invention is not limited thereto. For example, the resilient member 38 can be a metal spring as well. As for which one of the above-mentioned designs is adopted, it depends on practical demands. Furthermore, the circuit board 32 includes a switch 321 corresponding to each of the key switches 34, and the resilient member 38 has an activating portion 381 located in a position corresponding to the switch 321. When the key switch 34 is pressed, the resilient member 38 is compressed, such that the activating portion 381 of the resilient member 38 presses the switch 321 of the key switch 34, so as to perform a switch instruction, such as inputting words, symbols, numerals and so on. In this embodiment, the circuit board 32 can be a membrane, but the present invention is not limited there to. For example, the circuit board 32 can be a circuit board with switches as well. As for which one of the above-mentioned designs is adopted, it depends on practical demands.

Furthermore, the key switch 34 includes a lift support mechanism 40 disposed between the base 30 and the key cap 36. When the key switch 34 is pressed, the lift support mechanism 40 can evenly distribute the pressing force to the key cap 36, such that the key cap 36 moves toward the base 30 stably for activating the switch 321 and performing the switch instruction. When the key cap 36 is released and recovered, the lift support mechanism 40 can evenly distribute the resilient force applied by the resilient member 38 to the key cap 36, such that the key cap 36 moves away from the base 30 stably. In other words, the lift support mechanism 40 is used for activating the key cap 36 to move toward or away from the base 30, so as to stabilize the key cap 36 to approach or depart from the base 30 and facilitate stability of movement of the key switch 34.

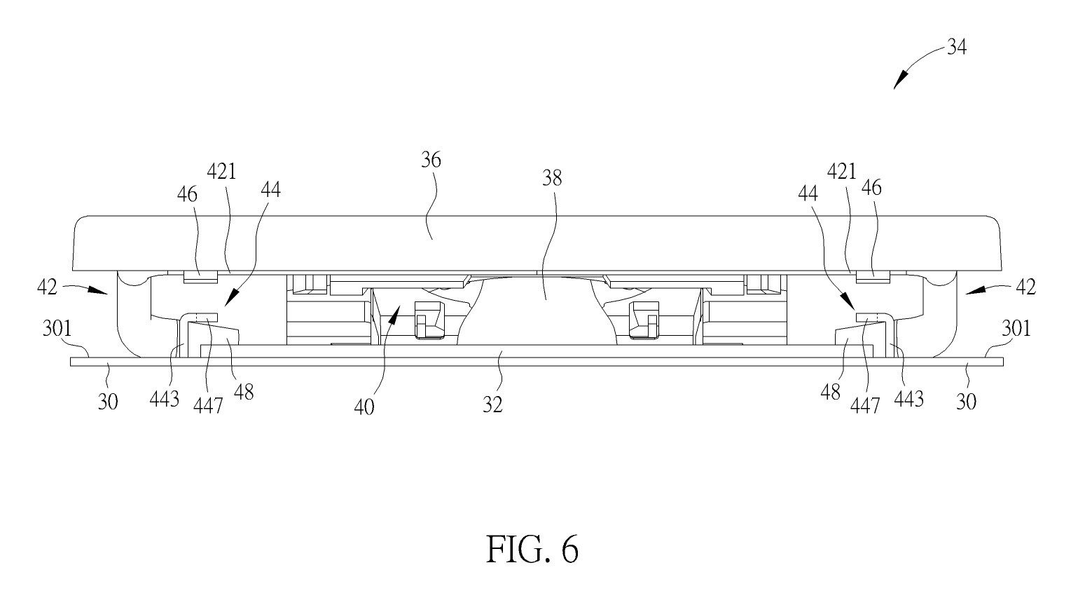

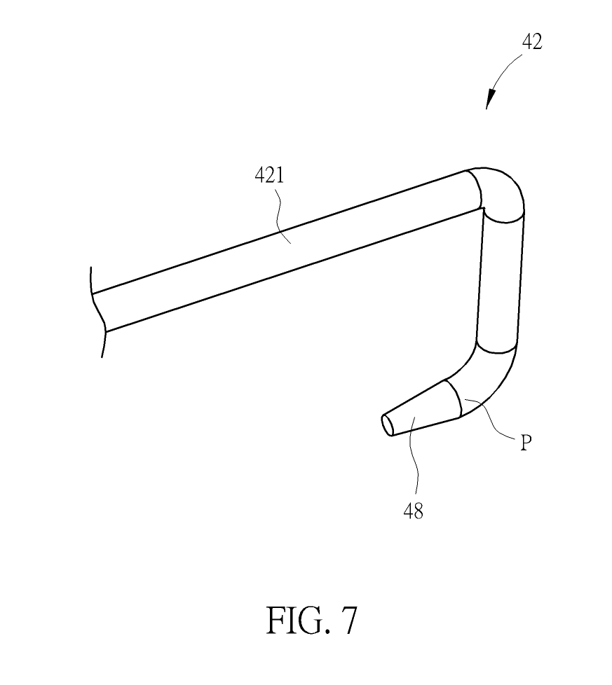

As shown in FIG. 2 to FIG. 5, the key switch 34 further includes at least one linkage bar 42 and two edge plates 44. The linkage bar 42 connects the key cap 36 and the base 30, and the edge plates 44 are connected to the base 30. Please refer to FIG. 3 to FIG. 7. FIG. 6 is a diagram of the key switch 34 in another view according to the embodiment of the present invention. FIG. 7 is a partly diagram of the linkage bar 42 according to the embodiment of the present invention. As shown in FIG. 3 to FIG. 7, at least one slot 441 is formed on the edge plate 44. The key switch 34 further includes a plurality of pivotal structures 46 and a plurality of sliding ends 48. The plurality of pivotal structures 46 is disposed on the key cap 36 and for making the key cap 36 be pivoted to a lateral portion 421 of the linkage bar 42. The plurality of sliding ends 48 is connected to an end P of the linkage bar 42. When the linkage bar 42 is assembled, the sliding end 48 of each of the linkage bars 42 is slidably disposed in the slot 441 and abuts against a top surface 301 of the base 30, and the lateral portion 421 of each of the linkage bar 42 is pivoted to the corresponding pivotal structure 46.

In this embodiment, the key switch 34 can include two linkage bars 42 and four sliding ends 48, and the four sliding end 48 are respectively connected to the end P of each of the linkage bars 42. The two edge plates 44 face each other, and two slots 441 are formed on each of the edge plates 44 for slidably latching the sliding ends 48. Accordingly, the lateral portion 421 and the sliding ends 48 of each of the linkage bars 42 are respectively installed in the corresponding pivotal structure 46 and the slots 441. Amounts of the linkage bar 42 and the slot 441 on each of the edge plates 44 are not limited to those illustrated in figures in this embodiment. For example, the key switch 34 can include one linkage bar 42 as well, and one slot 441 can be formed on each of the edge plates 44 correspondingly. In other words, structures that the key switch 34 include more than one linkage bar 42 and more than one slot 441 is formed on the edge plate 44 are within the scope of the present invention.

As shown in FIG. 5, when the key cap 36 is pressed, the sliding ends 48 connected to the two linkage bars 42 are capable of sliding in the slot 441 to approach each other, and the lateral portions 421 of the two linkage bars 42 are capable of pivoting in the corresponding pivotal structure 46. Meanwhile, the key cap 36 is activated by the lateral portions 421 of the two linkage bars 42 to approach the base 30. In other words, when the key switch 34 is pressed, the two linkage bars 42 cooperates with the lift support mechanism 40 for distributing the pressing force to the key cap 36, such that the key cap 36 moves toward the base 30 more stably. Similarly, when the key cap 36 is released, the resilient member 38 releases the potential energy to apply the resilient force on the key cap 36, so as to recover the keycap 36. During the process that the key cap 36 recovers, the sliding ends 48 connected to the two linkage bars 42 are capable of sliding in the slot 441 to depart from each other, and the lateral portions 421 of the two linkage bars 42 are capable of pivoting in the corresponding pivotal structure 46. Meanwhile, the key cap 36 is activated by the lateral portions 421 of the two linkage bars 42 to depart from the base 30. In other words, when the key switch 34 recovers, the two linkage bars 42 cooperates with the lift support mechanism for evenly distributing the resilient force applied by the resilient member 38 to the key cap 36, such that the key cap 36 moves away from the base 30 more stably. In other words, the linkage bar 42 can be used for driving the key cap 36 to approach or depart from the base 30, so as to stabilize the key cap 36 to lift and descend relative to the base 30 and thus to facilitate the stability of movement of the key switch 34.

As shown in FIG. 6 and FIG. 7, the edge plate 44 includes a latching portion 443 and a connecting portion 445. The connecting portion 445 is connected to a side of the latching portion 443 and an edge of the base 30. In this embodiment, the latching portion 443 can be substantially perpendicular to the connecting portion 445, and the slot 441 can be formed on the latching portion 443 and the connecting portion 445. Furthermore, the edge plate 44 further includes an extending portion 447 extending from another side of the latching portion 443. In this embodiment, the extending portion 447 can be substantially perpendicular to the latching portion 443, i.e. the extending portion 447 can be parallel to the connecting portion 445. In practical application, the latching portion 443, the connecting portion 445 and the extending portion 447 can be integrally formed in a stamping mold manner. It should be noticed that the extending portion 447 can be omitted, i.e. the edge plate 44 of the present invention can only include latching portion 443 and connecting portion 445 without the extending portion 447 for simplifying manufacturing process of the edge plate 44.

In addition, when the sliding end 48 connected to the linkage bar 42 is slidably disposed in the slot 441 on the edge plate 44, the sliding end 48 abuts against the top surface 301 of the base 30. In such a manner, the top surface 301 of the base 30 cooperates with the extending portion 447 of the edge plate 44 for preventing the sliding end 48 from turning over, such that the sliding end 48 slides in the slot 441 stably, so as to stabilize the linkage bar 42 to drive the key cap 36 to moves toward or away from the base 30. Furthermore, a cross section area of the sliding end 48 of the linkage bar 42 is smaller than a cross section area of the end P of the linkage bar 42. In this embodiment, the sliding end 48 can be a truncated conical structure with the cross section area decreasing along a direction away from the end P of the linkage bar 42, as shown in FIG. 7.

Since the cross section area of the truncated conical structure (i.e. the sliding end 48) is smaller than the cross section area of the end P of the linkage bar 42 and decreases along the direction away from the end P of the linkage bar 42, the truncated conical structure (i.e. the sliding end 48) approaches the top surface 301 of the base 30 when the truncated conical structure (i.e. the sliding end 48) abuts against the top surface 301 of the base 30. Accordingly, design of the truncated conical structure of the sliding end 48 is capable of decreasing height of the linkage bar 42 when the sliding end 48 abuts against the top surface 301 of the base 30. Since the lateral portion 421 of the linkage bar 42 is pivoted to the pivotal structure 46 of the key cap 36, the key cap 36 is activated by the lateral portion 421 of the linkage bar 42 to moves toward the top surface 301 of the base 30 when the height of the linkage bar 42 decreases. In such a manner, overall height of the key switch 34 decreases, and thus it advantages in designs of the key switch 34 and the keyboard 3 toward the trend with thin in size. In practical application, the sliding end 48 can be ground into the truncated conical shape.

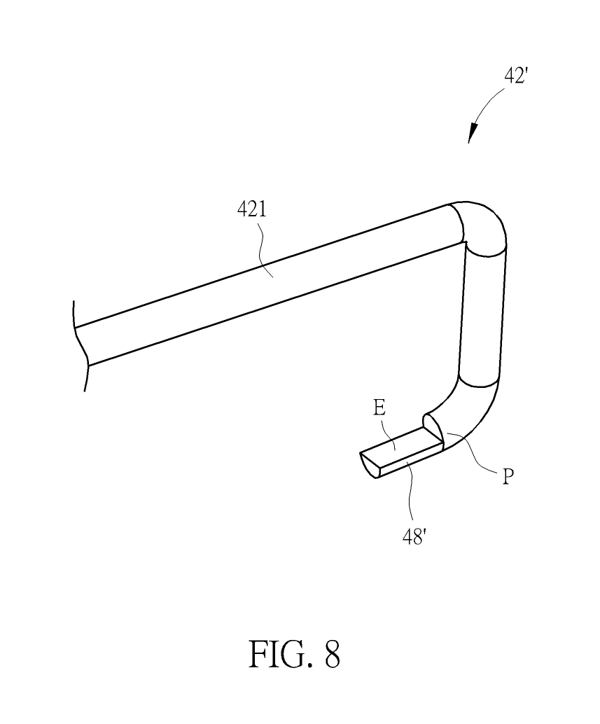

Please refer to FIG. 8. FIG. 8 is a partly diagram of a linkage bar 42′ according to another embodiment of the present invention. As shown in FIG. 8, the main difference between the linkage bar 42′ and the aforesaid linkage bar 42 is that a sliding end 48′ of an end P of the linkage bar 42′ is a rod with a cross section in substantially D shape, i.e. the sliding end 48′ is cut in the D-shaped rod with a plane E formed thereon, such that the cross section area of the D-shaped rod (i.e. the sliding end 48′) is smaller than the cross section area of the end P of the linkage bar 42′. In such a manner, when the sliding end 48′ abuts against the top surface 301 of the base 30, the D-shaped rod (i.e. the sliding end 48′) with the plane E is capable of reducing height of the linkage bar 42′, and thus it advantages in designs of the key switch 34 and the keyboard 3 toward the trend with thin in size.

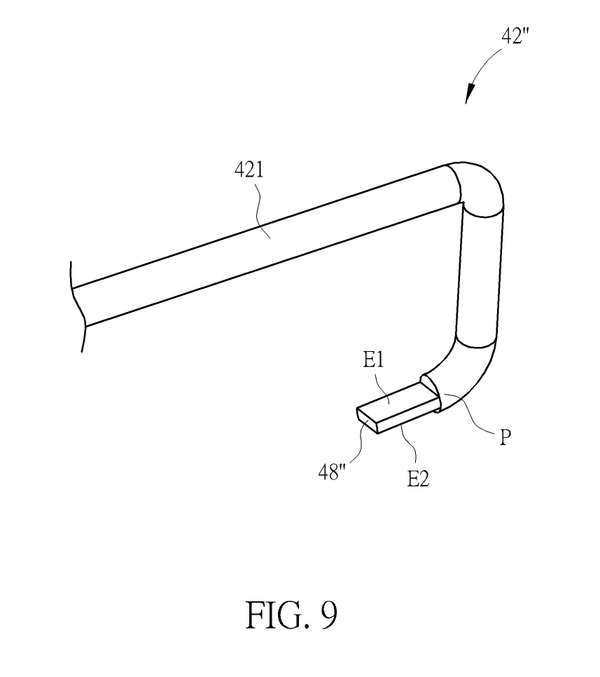

Please refer to FIG. 9. FIG. 9 is a partly diagram of a linkage bar 42″ according to another embodiment of the present invention. As shown in FIG. 9, the main difference between the linkage bar 42″ and the aforesaid linkage bar 42 is that a sliding end 48″ of an end P of the linkage bar 42″ is a rod with two planes E1, E2 formed thereon, and the two planes E1,E2 are opposite to each other, i.e. the sliding end 48″ is cut to be the rod with the two opposite planes E1,E2, such that the cross section area of the rod (i.e. the sliding end 48″) is smaller than the cross section area of the end P of the linkage bar 42″. In such a manner, when the sliding end 48″ abuts against the top surface 301 of the base 30, the rod (i.e. the sliding end 48″) with the two opposite plane E1,E2 is capable of reducing height of the linkage bar 42″, and thus it advantages in designs of the key switch 34 and the keyboard 3 toward the trend with thin in size.

Compared to the prior art, the cross section area of the sliding end connected to the end of the linkage bar of the present invention is smaller than the cross section area of the end of the linkage bar. When the sliding end abuts against the top surface of the base, the aforesaid structural design of the sliding end allows the sliding end to approach the base, so as to reduce the height of the linkage bar. Furthermore, the linkage bar is connected to the key cap, leading to that the key cap is activated by the linkage bar to move toward the base. In such a manner, the overall height of the key switch decreases, and thus it advantages in designs of the key switch and the keyboard toward the trend with thin in size.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A key switch disposed on a base of a keyboard, comprising:
a key cap disposed above the base;
an edge plate connected to the base, a slot being formed on the edge plate;
a linkage bar for connecting the key cap and the base; and
a sliding end connected to an end of the linkage bar, the sliding end being slidably disposed in the slot and abutting against a top surface of the base, a cross section area of the sliding end being smaller than a cross section area of the end of the linkage bar.

2. The key switch of claim 1, wherein the sliding end is a truncated conical structure with the cross section area decreasing along a direction away from the end of the linkage bar.

3. The key switch of claim 1, wherein the sliding end is a rod with a cross section in substantially D shape, and a plane is formed on the rod.

4. The key switch of claim 1, wherein the sliding end is a rod with two planes formed thereon, and the two planes are opposite to each other.

5. The key switch of claim 1, wherein the edge plate comprises:
a latching portion; and
a connecting portion connected to a side of the latching portion and an edge of the base, wherein the slot is formed on the latching portion and the connecting portion.

6. The key switch of claim 5, wherein the latching portion is substantially perpendicular to the connecting portion.

7. The key switch of claim 5, wherein the edge plate further comprises:
an extending portion extending from another side of the latching portion, the extending portion and the top surface of the base being cooperatively for preventing the sliding end from turning over.

8. The key switch of claim 7, wherein the extending portion is substantially perpendicular to the latching portion.

9. The key switch of claim 1, further comprising:
a pivotal structure disposed on the key cap, the pivotal structure being for making the key cap be pivoted to a lateral portion of the linkage bar, such that the key cap is activated by the lateral portion of the linkage bar to approach or depart from the base when the sliding end slides in the slot.

10. The key switch of claim 1, further comprising:
a lift support mechanism disposed between the base and the key cap, the lift support mechanism being for activating the key cap to move toward or away from the base.

11. A keyboard, comprising:
a base with a top surface; and
at least one key switch disposed on the base, comprising:
a key cap disposed above the base;
an edge plate connected to the base, a slot being formed on the edge plate;
a linkage bar for connecting the key cap and the base; and
a sliding end connected to an end of the linkage bar, the sliding end being slidably disposed in the slot and abutting against a top surface of the base, a cross section area of the sliding end being smaller than a cross section area of the end of the linkage bar.

12. The keyboard of claim 11, wherein the sliding end is a truncated conical structure with the cross section area decreasing along a direction away from the end of the linkage bar.

13. The keyboard of claim 11, wherein the sliding end is a rod with a cross section in substantially D shape, and a plane is formed on the rod.

14. The keyboard of claim 11, wherein the sliding end is a rod with two planes formed thereon, and the two planes are opposite to each other.

15. The keyboard of claim 11, wherein the edge plate comprises:
a latching portion; and
a connecting portion connected to a side of the latching portion and an edge of the base, wherein the slot is formed on the latching portion and the connecting portion.

16. The keyboard of claim 15, wherein the latching portion is substantially perpendicular to the connecting portion.

17. The keyboard of claim 15, wherein the edge plate further comprises:
an extending portion extending from another side of the latching portion, the extending portion and the top surface of the base being cooperatively for preventing the sliding end from turning over.

18. The keyboard of claim 17, wherein the extending portion is substantially perpendicular to the latching portion.

19. The keyboard of claim 11, wherein the key switch further comprises:
a pivotal structure disposed on the key cap, the pivotal structure being for making the key cap be pivoted to a lateral portion of the linkage bar, such that the key cap is activated by the lateral portion of the linkage bar to approach or depart from the base when the sliding end slides in the slot.

20. The key switch of claim 11, wherein the key switch further comprises:
a lift support mechanism disposed between the base and the key cap, the lift support mechanism being for activating the key cap to move toward or away from the base.
